(19) United States
(12) Patent Application Publication
(10) Pub. No.: US 2009/0121437 A1
(43) Pub. Date: May 14, 2009

(54) Five Card Omaha played againest the dealer

(75) Inventors: Roger M. Snow, Las Vegas, NV (US); Robert P. Scott, Las Vegas, NV (US)

Correspondence Address: Thomas J. D'Amico;Dickstein Shapiro LLP, 1825 Eye Street , NW, Washington, DC, 20006-5403, US

(73) Assignee: Shuffle Master, Inc.

(21) Appl. No.: 11/983,471

(22) Filed: Nov. 9, 2007

(51) Int. Cl. A63F 13/00

(52) U.S. Cl. 273/303; 273/292; 463/13; 463/27; 463/32; 463/42

(57) ABSTRACT

A card game with an optional side bet and methods for playing this game. The method comprises the player placing an ante bet and a blind bet to enter the game and optionally placing the optional side bet. The dealer deals a plurality of Hole cards to the players, and the players are then given the option to place a first play bet or check. The dealer deals a plurality of community cards, turning at least one of the community cards face up, and the players are given the option to place a second play bet or check. The dealer turns the remaining community cards face up, and the players are then given the option to place a third play bet or check. The dealer receives a plurality of dealer Hole cards. After the dealer Hole cards are revealed, the hands are determined by combining two dealer Hole cards with the community cards to form a dealer's hand. The ante, blind, play and optional bets are then resolved, the optional side bet resolved according to a predetermined criteria.

### FIELD OF THE INVENTION

The present invention is directed to a card game, and more particularly to a variant game of poker.

### BACKGROUND OF THE INVENTION

Many different betting games presently exist for use in both home and casino environments. Such games should necessarily be exciting, not excessively complicated, and must be relatively easy to learn so as to avoid frustrating the players.

Poker games in particular have gained widespread popularity because of their well-known rules and long-established ranking of hands. Furthermore, poker games usually involve numerous betting opportunities for the players, thus increasing player participation and excitement. Poker games move fairly quickly, which enhances player interest. All of these factors have created games that are widely accepted and widely known.

Five Card Omaha is one known poker game that shares many of the same rules of Texas Hold 'Em and is traditionally played in poker rooms against other players. In general, players compete against each other to achieve the best poker hand based on a best two out of four individual Hole cards and three out of five community cards. Players place bets into a pot during numerous rounds of betting, and the winning player collects the pot at the end. FIG. 1 is a flowchart showing a method for playing Five Card Omaha.

Looking at FIG. 1, before cards are dealt, the first step 101 requires that any preliminary forced bets, such as the ante bet and/or the blind bet, be made. An ante bet requires each player to place a set amount of money in the pot as a means of ensuring that the winning player will receive some amount of money in the unlikely event that no other bets are placed. A blind bet typically requires one or two players to place an initial bet of a set amount which must then be matched by the remaining players during the first round of play betting. The responsibility to pay the blind is typically rotated each game from one player to the next. Where two players pay the blind in a game, one player typically pays the “big blind,” and another player pays the “little blind,” which is typically half of the “big blind.” The result of this is that the player paying the “little blind” must pay at least half of the “big blind” during the first round of play betting to remain in the game.

In the next step 102, each player is dealt four individual cards, called Hole cards, face down and visible only to the player. In the next step 103, the player is given the option to make a first play bet by betting, calling or raising. This is referred to as the Pre-Flop bet. The purpose of this, and each successive play bet is to bet on the strength of a player's poker hand and predicted ultimate poker hand compared to the hands of all of the other players. The purpose of a play bet, though, may also be to bluff. During the Pre-Flop bet, the player is betting that he or she will have the best poker hand based only on the knowledge of his or her own Hole cards, two of which will eventually be used to form the player's hand. The player may also check or fold, but may only check if the other players have not yet bet or if the player has already matched the other players' bets. If the player folds 113, any bets made to that point are forfeited and the player is out of the game.

For all players who have not folded, the next step 104 is called the Flop, where the dealer reveals three community cards. To do this, the dealer may deal all three cards face down and then turn them up simultaneously. In the next step 105, the player is given the option to place a second play bet by betting, calling or raising. This is referred to as the Flop bet. As with the previous play bet, the player is betting that he or she will have the best poker hand, but now the player has knowledge of three community cards that may be used with two of the player's Hole cards to form the player's poker hand. As with the Pre-Flop bet, the player may check or fold, but may only check if the other players have not yet bet or if the player has already matched the other players' bets. If the player chooses to fold, the next step 113 is that any bets made to that point are forfeited and the player is out of the game.

For all players who have not folded, the next step 106 is called the Turn, where the dealer then deals the fourth community card face up. In the next step 107, the player is given the option to place a third play bet by betting, calling or raising. This is referred to as the Turn bet. As with previous play bets, the player is betting that he or she will have the best poker hand, but now the player has knowledge of four community cards that may be used with two of the player's Hole cards to form the player's poker hand. As with the Pre-Flop and Flop bets, the player may check or fold, but may only check if the other players have not yet bet or if the player has already matched the other players' bets. If the player chooses to fold, the next step 113 is that any bets made to that point are forfeited and the player is out of the game.

For all players who have not folded, the next step 108 is called the River, where the dealer deals the fifth and final community card face up. In the next step 109, the player is given the option to place a fourth play bet by betting, calling or raising. This is referred to as the River bet. As with previous play bets, the player is betting that he or she has the best poker hand, but now the player has knowledge of all five community cards, three of which are used with two of the player's Hole cards to form the player's best five-card poker hand. As with the Pre-Flop, Flop and Turn bets, the player may check or fold, but may only check if the other players have not yet bet or if the player has already matched the other players' bets. If the player chooses to fold, the next step 113 is that any bets made to that point are forfeited and the player is out of the game.

For all players who have not folded, the next step 110 is called the Showdown, during which the players compare their hands with each other. A player's hand is determined by a player choosing two of his or her four Hole cards and combining them with any three of the five community cards to form the best five card poker hand possible. In the next step 111, the player with the highest five-card poker ranking wins. All other players forfeit all bets to the winner and lose, unless there is a tying hand, whereupon the pot is split between tying players.

Poker games that place all players against the house, as opposed to against each other, are desirable as a means for generating income for the house. Such a method of playing poker can also simplify the implementation of the game in a video form as only one player is required.

Accumulating a great poker hand is no guarantee that a player will be rewarded. Under most circumstances, a straight flush is a great hand, unusual and requiring skill and luck to assemble, thus a player should be rewarded accordingly. Unfortunately, a royal flush is even better. With most poker formats, if a player's hand has been beaten by the any of the other players' hands or the dealer's hand, the player will not be entitled to a payout.

Therefore it is desirable to create a format for playing Five Card Omaha where all players play against the house, not each other, and that rewards players that otherwise play well, but may not have a better hand than the dealer.

### BRIEF DESCRIPTION OF THE DRAWINGS

FIG. 1 is a flowchart illustrating a method of playing Five Card Omaha.

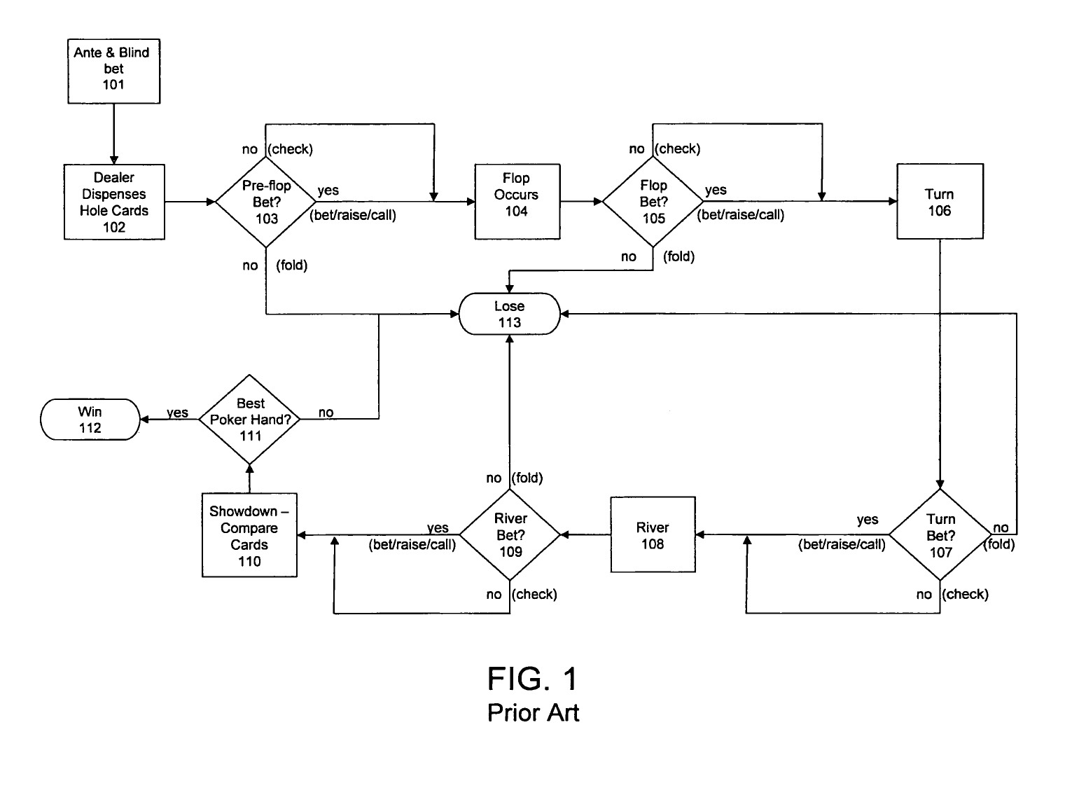

FIG. 2 is a flowchart illustrating a method of playing Five Card Omaha according to an embodiment described herein.

FIG. 3 is a paytable for paying bonus bets according to an embodiment described herein.

FIG. 4 is a paytable for paying blind bets according to an embodiment described herein.

FIG. 5 is a layout design for use in practicing an embodiment of the method of the present invention.

FIG. 6 is an expanded view of a player position of the layout design of FIG. 5.

FIG. 7 shows a game device for playing a game according to an embodiment described herein.

### DETAILED DESCRIPTION OF THE INVENTION

In the following detailed description, reference is made to various embodiments of the invention that are described with sufficient detail to enable those skilled in the art to practice them. It is to be understood that other embodiments may be employed, and that various changes may be made without departing from the scope of the invention. The progression of steps and device features described are exemplary of embodiments of the invention; however, the steps, sequence thereof, and devices are not limited to those set forth herein and may be changed as is known in the art, with the exception of steps necessarily occurring in a certain order.

Various embodiments described herein relate to a method for playing a variant of Five Card Omaha. The present invention is a house-banked game based on traditional Five Card Omaha. That is, all players compete against a dealer (i.e. the house/casino), not other players. Also, the present invention is directed to a method for playing Five Card Omaha with an optional bonus bet that pays poker hands according to predetermined criteria regardless of whether the player's hand has a higher poker ranking than the dealer's hand.

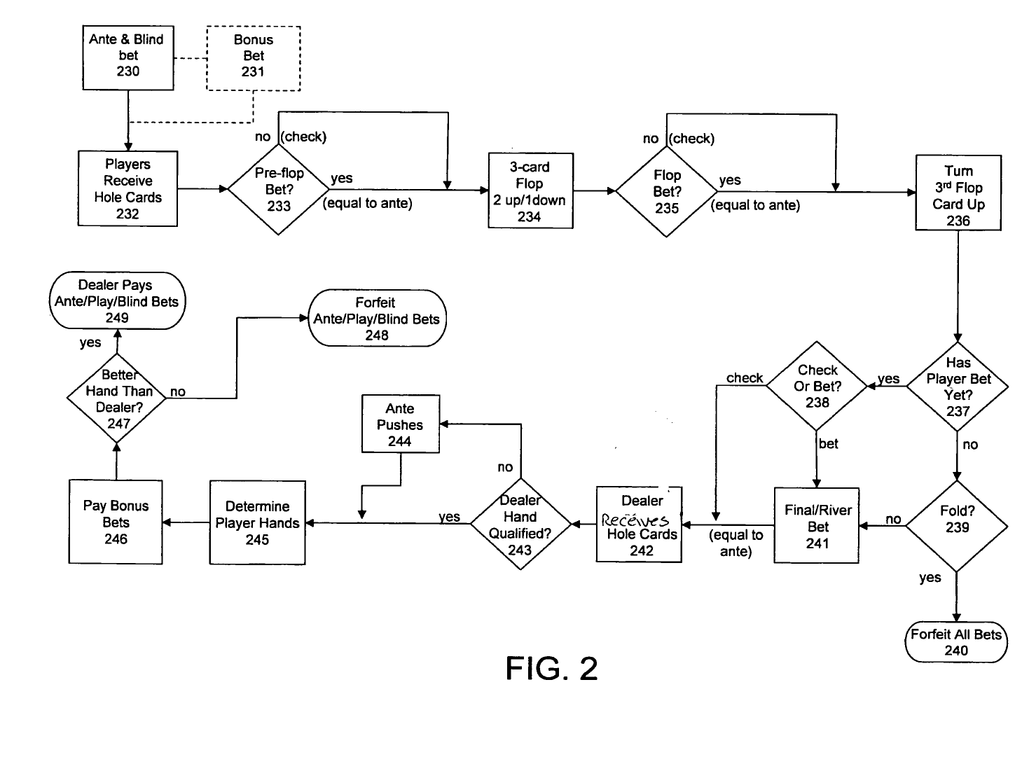

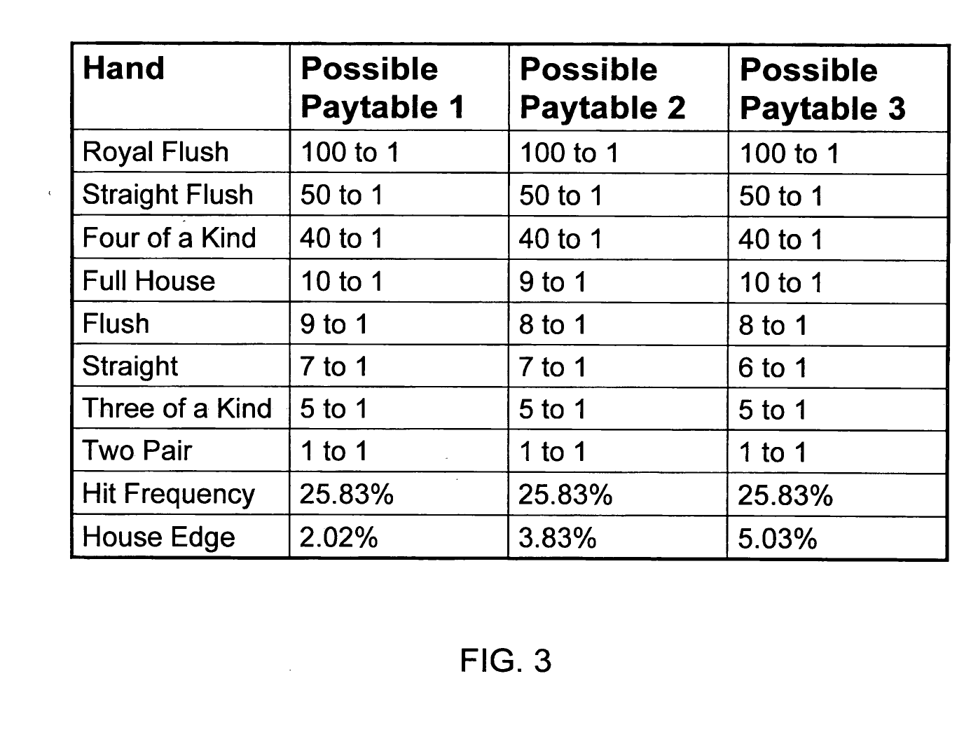

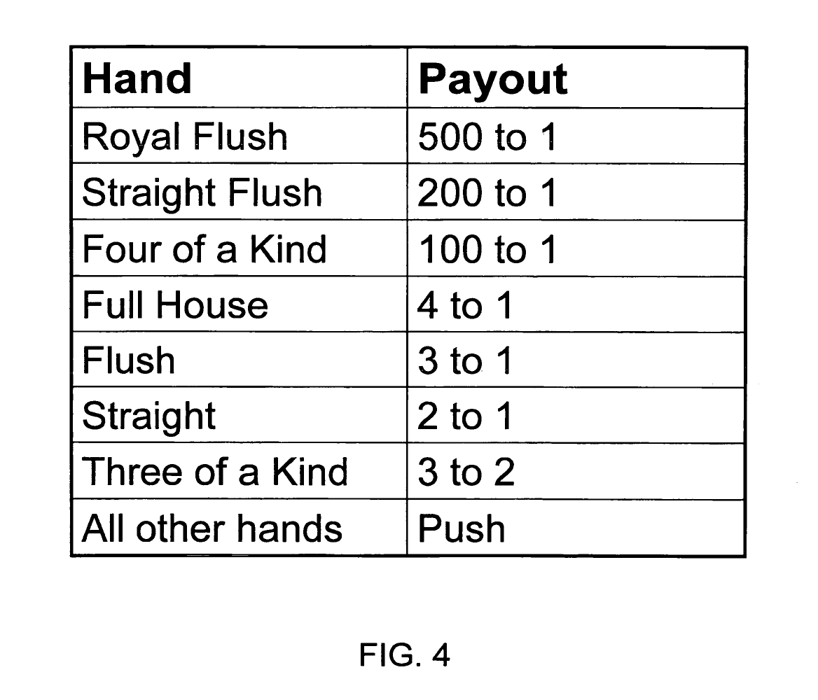

Now referring to the figures, FIG. 2 illustrates a method of the invention according to a first embodiment. Before cards are dealt, the first step 230 includes that at least one of an ante bet or blind bet are made by each player. In a preferred embodiment, both the ante and blind bets are mandatory. In one embodiment, the blind and ante bets must be equal. Similar to traditional Five Card Omaha, the ante bet forces a player to bet something on the game, as most or all of the other bets will be optional. Also, in a preferred embodiment, a main purpose of the ante is to establish a value that all play bets of that player must be equal to. If for instance the player makes a $5.00 ante, all additional bets are fixed at $5.00 in one embodiment. A blind bet payout, unlike traditional Five Card Omaha, is paid to a player with a predetermined high ranking hand that also beats the dealer hand. Predetermined winning hands may be listed in a paytable, one embodiment of which is shown in FIG. 4. In order to win the blind bet, the player hand must beat the dealer hand. An optional next or concurrent step 231 allows each player to also place a bonus bet which will be paid regardless of whether the player's hand has a higher ranking than the dealer's hand. The bonus bet is a pure gamble on whether the player will have a paying poker hand per a predetermined criteria. In a preferred embodiment, the predetermined criteria is a paytable, examples of which are shown in FIG. 3. In one embodiment, the bonus bet as well as the ante and blind bets may be subject to a required minimum and/or maximum.

In the next step 232, each player is dealt at least three, and in one example, four Hole cards face down, viewable only by the player. In the next step 233 the player is then given the option to check or make a first play bet, referred to as the Pre-Flop bet. Because the players are playing against only the dealer, not each other, the ability of a player to check is not dependent on bets of the other players as in traditional Five Card Omaha. The players, however, may not fold at this point in the game. In a preferred embodiment the Pre-Flop bet must be equal to the ante.

Once Pre-Flop betting is concluded, the next step 234 is called the Flop where three community cards are dealt face down. In one embodiment, two of three dealt community cards are immediately revealed. The next step 235 gives the player the option to check or place a second play bet, referred to as the Flop bet. As with the Pre-Flop bet, the player may check independent of the betting of the other players and may not fold. In alternative embodiments, a single card of the Flop may be revealed at a time, providing additional betting opportunities, or all Flop cards can be revealed simultaneously. In a preferred embodiment, the Flop bet must be equal to the ante.

Once all players have decided whether to place a Flop bet, in the next step 236, called the River, the dealer turns over the third and last community card. After the third community card is revealed, the next steps 237, 238, 239 again give each player a series of options. This time, however, the options available to each player are dictated, in part, by whether that player has placed a bet in any of the previous play betting opportunities 233, 235, or if that player has instead checked every time.

The first step 237 is to determine whether a player has placed at least one additional bet (after the ante) during the previous play betting opportunities 233, 235. If the player has placed at least one bet and did not check in all of the previous play betting opportunities 233, 235, the next step 238 for that player is to choose whether to check or place a third play bet, referred to as a River Bet. If the player chooses to bet, the next step 241 for the player will be to place a River Bet. In a preferred embodiment, the River Bet must be equal to the ante.

Looking back, at step 237, if the player has not placed at least one bet after the ante and did check in all of the previous play betting opportunities 233, 235, the next step 239 for that player is to decide whether to fold or bet. The player may not check if he checked all previous play bets. If a player decides to fold, the final step 240 for the player is to forfeit the ante, blind and bonus bets to the house and the game is over for that player. If a player decides not to fold, the next step 241 for that player is to place a River bet.

While the play bets placed at steps 233, 235 and 241 in the preferred embodiment must all be equal to the ante, the play bets can be any amount that allows the house to maintain an advantage. The house advantage is provided by the dealer qualification step.

For all players who placed a River bet or checked, the next step 242 is for the dealer to reveal his or her four Hole cards. The dealer's Hole cards can be dealt face down and then revealed, or can be dealt face up. A preferred time for receiving the cards is after betting has concluded.

The next step 243 is to determine whether the dealer's hand qualifies. In one embodiment, the dealer's hand qualifies only if it has a poker ranking of a pair or better. In alternative embodiments, other qualifying hands can be used such as two pair, one pair of a qualifying value, or three of a kind. If the dealer's hand does not qualify, in the next step 244 each player's ante bet pushes and is returned to the player. The play bets remain in play. The dealer's hand is determined by combining two of the dealer's Hole cards with the three community cards to make a hand with the best available five-card poker ranking. In the present embodiment, there are only three community cards so that all community cards will be used in each hand, but other embodiments may include more community cards, which would require the dealer, and subsequently each player, to choose only three of the community cards for his or her hand.

The next step 245 is to determine the players' hands. Each player's hand is determined in the same manner that the dealer's hand was determined, by combining two Hole cards with the three community cards (or alternatively the best three community cards), out of four or more community cards to make a hand with the best available poker ranking.

The next step 246 is for the house to pay winning bonus bets. Bonus bets are paid according to a bonus bet paytable, such as the three example bonus paytables shown in FIG. 3. Bonus bets can be paid at any time after all cards are revealed. In one embodiment bonus bets are paid after all play bets have been made and all cards revealed. In this embodiment, bonus bets are paid before the players' hands are compared with the dealer's hand because bonus bets are paid regardless of whether the player's hand beats the dealer's hand. Any bonus paytable that maintains the preferred house edge may be used.

After the bonus bets are paid, the next step 247 is the Showdown where each player's hand is compared with the dealer's hand based on standard poker rankings. If the poker ranking of a player's hand is less than the poker ranking of the dealer's hand, the next step 248 is that the player loses and forfeits all play bets, the ante bet and the blind bet to the house. If the poker ranking of a player's hand is better than the poker ranking of the dealer's hand, (and the dealer hand qualifies) the next step 249 is that the house must pay all of the winning player's play bets, the ante bet and the blind bet. The dealer hand must qualify for payment on the Ante. In one embodiment, the ante bet and all play bets are paid 1-to-1. The blind bet, however, is paid according to a blind bet paytable. An example of a blind paytable is shown in FIG. 4. The player hand must beat the dealer hand to qualify for a blind bet payout.

As is shown in FIG. 2, in one embodiment the blind, play and ante bets are only paid if the player's hand beats the dealer's hand (and the dealer hand qualifies), while the bonus bet is paid regardless of whether the player's hand beats the dealer's hand. Also, as is shown in FIG. 2, the ante bet is paid only if the dealer's hand qualifies, while the blind, play and bonus bets are paid regardless of whether the dealer's hand qualifies.

In the event of a tie, all wagers are a push.

The present embodiment is only one example of how the community cards may be revealed. The community cards can be revealed in different increments including more or less betting opportunities. Furthermore, the present invention may include any number of community cards. Moreover, the present invention may include any number of Hole cards dealt to each player and the dealer. It is further understood that while the above embodiment is based on a five card poker ranking, other known poker rankings, such as three, four or seven card rankings could also be used, as well as variations in the number of community cards dealt, and not deviate from the scope of the invention.

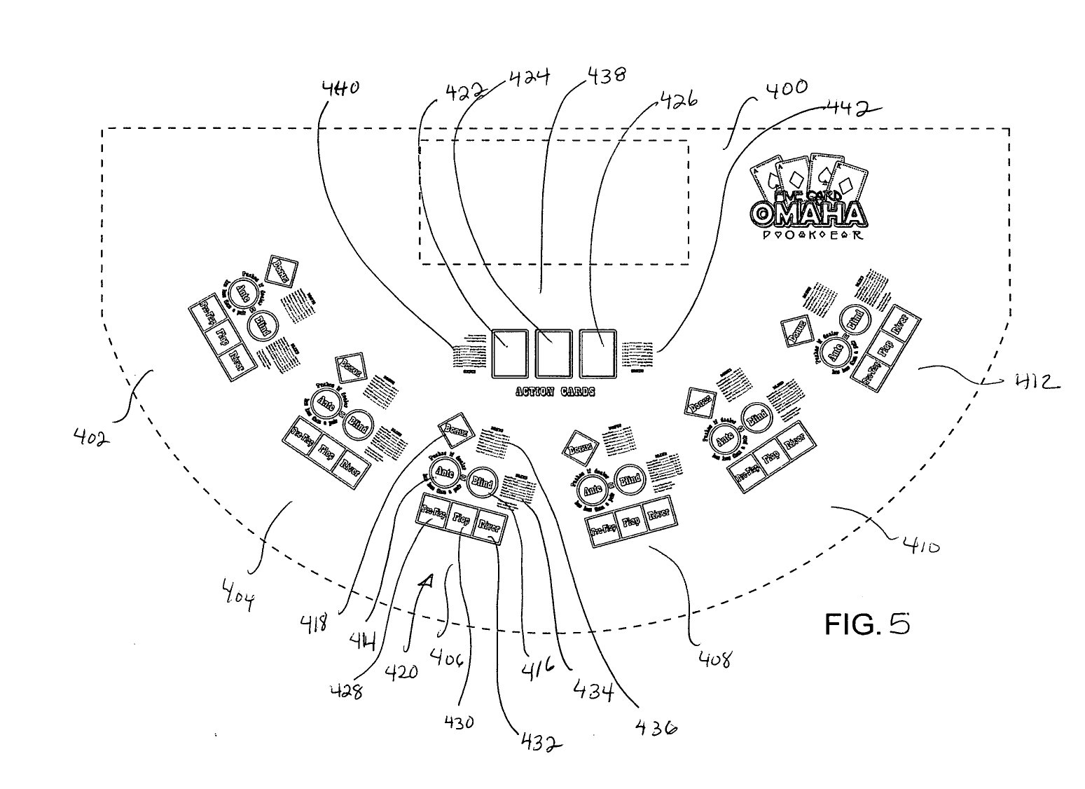

The games of the present invention may be played on a layout such as the one shown in FIG. 5.

FIG. 5 shows a layout 400 that includes six player areas 402, 404, 406, 408, 410 and 412. Each betting area is substantially identical. References to elements of one player area applies to the other player areas.

Each player area 402 has an ante wagering area 414, a blind wagering area 416 and a bonus wagering area 418. After the player has made the desired wagers, a dealer deals four cards, face-down into card area 420. Players may inspect the cards, but the cards remain face-down. The common cards, also referred to as “action” cards, are dealt face down into card areas 422, 424 and 426.

Pre-flop, flop and river wagers are placed in respective betting areas 428, 430, 432. The blind wager is resolved against a pay table 434, and the bonus wager is resolved against a pay table 436, both printed on the table felt.

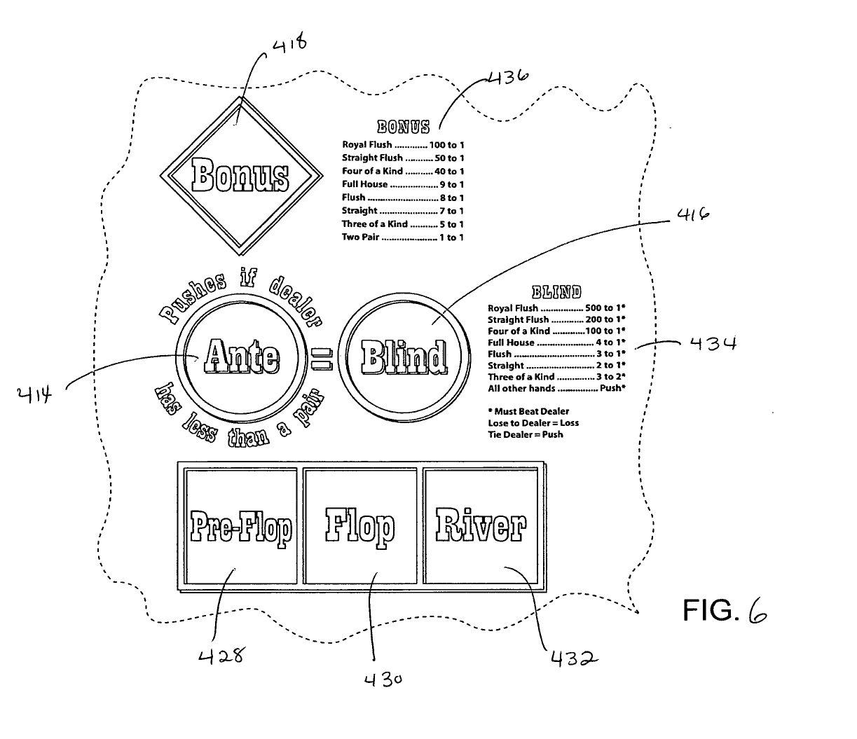

The dealer flop cards are dealt face-down into card area 438. The bonus and blind pay tables may also be printed in areas 440, 442 respectively for the convenience of the dealer. A detailed view of player position 406 is shown in FIG. 6.

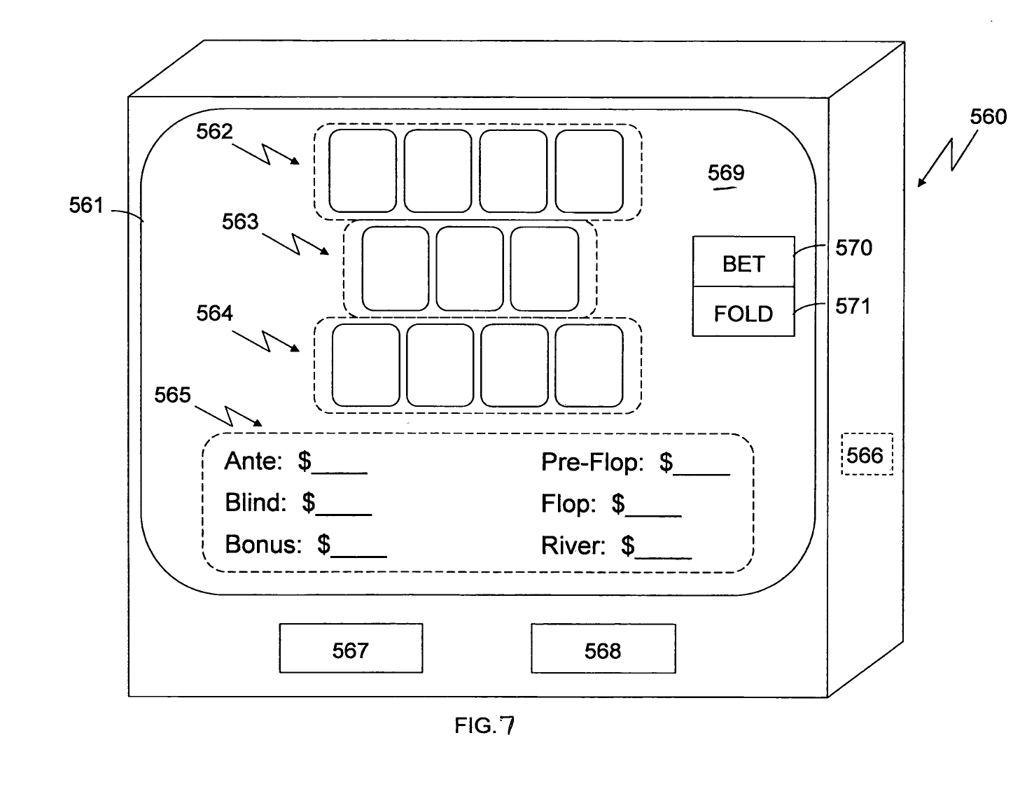

The gaming methods described in this application may be played in a number of different formats, such as a live action casino gaming format with a live dealer and real playing cards and chips, or with various automated formats with partial or complete automation of the format. Such formats include traditional video gaming apparatus and modern multi-player platforms. Methods of the present invention may be played in a practice-play format on a personal computer, cell phone or personal gaming platform such as a Nintendo® or Sony Play Station®. Remote wagering such as internet or wireless gaming are also suitable formats to practice the method. An embodiment of one suitable video gaming format is shown in FIG. 7.

FIG. 7 shows a game machine 560, which has a video screen 561. The video screen 561 can be an LCD, CRT, plasma, or any other type of video screen. The video screen 561 may show a player's Hole cards 562, the community cards 563, and the dealer's Hole cards 564, where the dealer's Hole cards are revealed only after the player places the River bet. The video screen 561 may also show the value of each bet that a player has placed 565. The game machine 560 may be a stand-alone unit, may be internet-connected or may be networked with other machines. The game machine 560 can have a processor 566 programmed to run a game as discussed above in relation to FIGS. 2-4, which may be played by a player. The game machine 560 can utilize a touch screen 569 such that the machine 560 receives input from the player by the player touching the screen 561. Commands for betting and folding can be input during a game using virtual buttons 570 and 571 via the touch screen 569.

The game machine 560 can include a means for accepting money to play the game 567; for example a coin, token or bill acceptor, a credit or debit card or other card slot, or other means of accepting payment. Such a machine 560 may also include a payout slot 568 so that a winning player receives payout as he or she would at a casino table. The payout slot may dispense coins, bills, tokens or receipts than can be exchanged for currency. The above description and drawings should be considered illustrative of example embodiments that achieve the features and advantages of the invention. Accordingly, the invention is not to be considered as being limited by the foregoing description and drawings, but is only limited by the scope of the appended claims.

What is claimed as new and desired to be protected by Letters Patent of the United States is:

1. A method of playing a game, between a dealer and at least one player, comprising:
dealing a plurality of at least three hole cards to each player, a number of hole cards exceeding the number of hole cards used to form part of the player hand;
incrementally revealing a plurality of community cards;
providing each player at least one opportunity to bet;
dealing a plurality of at least three hole cards for the dealer, a number of hole cards exceeding the number of hole cards used to form part of the dealer hand;
combining two dealer hole cards with at least some of the community cards to form a dealer hand;
identifying each player's best hand based on two player hole cards and all of the community cards;
comparing each player's hand with the dealer hand based on poker rankings; and
resolving all bets.

2. The method of claim 1, wherein each player is required to place at least one of an ante and a blind bet before the hole cards are revealed,
wherein each player is allowed to place an optional side bet,
wherein each player is provided an opportunity to place a first play bet or check before any community cards are revealed, and
wherein each player is provided an opportunity to place at least one other play bet or check after each increment of revealing community cards.

3. The method of claim 1, wherein four hole cards are dealt to each player and to the house.

4. The method of claim 2, wherein a total three community cards are revealed in two increments, two cards in a first increment and one card in second increment.

5. The method of claim 2, wherein all play bets must each be equal to the ante bet.

6. The method of claim 2, wherein the ante, blind and play bets are resolved in favor of the player only if the player hand achieves a higher poker ranking than the house hand.

7. The method of claim 2, wherein the ante bet pushes if the house hand does not qualify.

8. The method of claim 7, wherein the house hand qualifies with a pair or better.

9. The method of claim 2, wherein the blind bet is paid according to an odds paytable.

10. The method of claim 2, wherein the bonus bet is paid according to a predetermined criteria.

11. The method of claim 10, wherein the predetermined criteria is an odds paytable.

12. The method of claim 1, wherein the house hand and each player hand consist of five cards.

13. The method of claim 2, wherein a player may check after the final community card is revealed only if that player has not checked during every opportunity to place play bets and a player may fold after the final community card is revealed only if no play bets were made.

14. The method of claim 1, wherein five card poker rankings are used to compare player and house hands.

15. A method of administering a betting game between a dealer and at least one player, comprising:
requiring the at least one player to place an ante bet and a blind bet;
allowing the player to place an optional bonus bet;
dealing four hole cards to the player and four hole cards to the dealer;
dealing three community cards;
allowing the player to check or make a first play bet after viewing the player's hole cards; and
revealing each of the community cards in at least two increments and allowing the player to check or place a play bet after each said increment, wherein after all community cards have been revealed the player may not thereafter check unless the player has previously placed at least one play bet during the ongoing game and the player may not thereafter fold unless the player has checked on every allowed occasion during the ongoing game, and
wherein the player is paid on the ante, blind and play bets only when the player's hand consisting of two player hole cards and the three community cards outranks the dealer's hand, the blind bet being paid according to a blind paytable and the bonus bet being paid according to a bonus paytable.

16. The method of claim 15, wherein after all community cards have been revealed, the player optionally checks, folds or makes a final play bet before the player's hand is compared to the dealer's hand based on predetermined poker rankings.

17. The method of claim 15, wherein the community cards are revealed in at least two increments.

18. The method of claim 15, wherein all of the player's play bets must be equal.

19. The method of claim 18, wherein all of the player's play bets must be equal to the player's ante bet.

20. The method of claim 15, wherein the blind paytable is:

| Hand | Odds |
|---|---|
| Royal Flush | 500:1 |
| Straight Flush | 200:1 |
| Four-of-a-kind | 100:1 |
| Full House | 4:1 |
| Flush | 3:1 |
| Straight | 2:1 |
| Three of a kind | 3:2 |
| All other hands | Push |

21. The method of claim 15, wherein the bonus paytable is:

| | |
|---|---|
| Royal Flush | 100:1 |
| Straight Flush | 50:1 |
| Four-of-a-kind | 40:1 |
| Full house | 10:1 |
| Flush | 9:1 |
| Straight | 7:1 |
| Three-of-a-kind | 5:1 |
| Two Pair | 1:1 |

22. The method of claim 15, wherein the bonus paytable is:

| | |
|---|---|
| Royal Flush | 100:1 |
| Straight Flush | 50:1 |
| Four-of-a-kind | 40:1 |
| Full house | 9:1 |
| Flush | 8:1 |
| Straight | 7:1 |
| Three-of-a-kind | 5:1 |
| Two Pair | 1:1 |

23. The method of claim 15, wherein the bonus paytable is:

| | |
|---|---|
| Royal Flush | 100:1 |
| Straight Flush | 50:1 |
| Four-of-a-kind | 40:1 |
| Full house | 10:1 |
| Flush | 8:1 |
| Straight | 6:1 |
| Three-of-a-kind | 5:1 |
| Two Pair | 1:1 |

24. A game machine comprising:
a video screen;
a player input device;
a payment input device;
a payout device;
a processor configured to perform at least the following steps:
dealing at least three hole cards to the player;
incrementally revealing three community cards;
providing the player at least one opportunity to bet;
dealing at least three house hole cards for a house hand;
combining two house hole cards with the three community cards to form a five-card house hand;
identifying the player's best five-card hand based on two player hole cards and three of the community cards;
comparing the player's hand with the house hand based on poker rankings; and
resolving all bets.

25. The game machine of claim 24, wherein the steps are implemented as a multi-player video game.
